(19) United States
(12) Patent Application Publication
(10) Pub. No.: US 2026/0159713 A1
(43) Pub. Date: Jun. 11, 2026

(54) BIOBASED COATINGS FOR FOOD SERVICE ITEMS

(71) Applicants: HOFFMASTER GROUP, INC., Clintonville, WI (US); North Carolina State University, Raleigh, NC (US)

(72) Inventors: Mark HUNTER, Green Bay, WI (US); Lokendra PAL, Raleigh, NC (US); Moumita DEY, Raleigh, NC (US); Kendra FEIN, Neenah, WI (US)

(21) Appl. No.: 19/334,475

(22) Filed: Sep. 19, 2025

Related U.S. Application Data
(60) Provisional application No. 63/696,841, filed on Sep. 19, 2024.
(60) Provisional application No. 63/745,431, filed on Jan. 15, 2025.

(51) Int. Cl. C09D 103/12

(52) U.S. Cl. CPC C09D 103/12

(57) ABSTRACT

Aspects of the present disclosure include a biobased coating composition comprising at least one modified starch, at least one crosslinker, at least one plasticizer and at least one pH adjuster, wherein the at least one crosslinker is a citric acid crosslinker present in an amount ranging from 1 to 10 percent by weight of the biobased coating composition. Further aspects of the present disclosure include paper plate comprising a biobased coating composition comprising at least one modified starch, at least one crosslinker, at least one plasticizer and at least one pH adjuster, wherein the at least one crosslinker is a citric acid crosslinker present in an amount ranging from 1 to 10 percent by dry weight of the biobased coating composition. Additional aspects of the present disclosure include a biobased coating composition comprising at least one modified starch, at least one petroleum-based polymer, at least one crosslinker, at least one plasticizer and at least one pH adjuster, wherein the at least one petroleum-based polymer is present in an amount ranging from 1 to 50 percent by weight of the biobased coating composition.

Biobarrier coatings have received increased attention in recent years as a replacement, in full or in part, of plastic-based materials due to their environmentally-friendly nature and consumer satisfaction. The present disclosure is directed to high-performance starch-based biobarrier coatings that enhance the chemical, mechanical, and/or barrier properties of recyclable, compostable, or biodegradable paper products used for food service applications.

Food packaging is extremely important in the food industry as it is related to safe food production and delivery. Commonly used food packaging materials, such as polyethylene terephthalate, polyethylene, polyvinyl chloride, polypropylene, and polystyrene, are made solely from petroleum-based chemicals. Disposable food dinnerware made from petroleum-based chemicals has become increasingly popular in recent years as they are lightweight, relatively inexpensive, and have no washing burden. The production of these packaging materials made solely from petroleum-based materials, however, require disposal after use and this disposal is raising environmental concerns.

Paper-based materials have long been used to package liquids and fatty foods. When plastics were first introduced for food packaging, paper-based materials began to decline in prominence. Some current packaging trends have returned to paper-based materials and are heavily influenced by sustainability initiatives and the public's growing distaste for plastics. Recent efforts are concentrated on environmentally-friendly packaging made from renewable resources that are reusable, recyclable, compostable, and biodegradable. In contrast to petroleum-based packaging, paper-based materials provide the benefits of high recyclability, biodegradability, and compostability.

Unfortunately, raw or traditional clay-coated paper and paperboard can be inadequate food packaging barriers because of their porous structure and the hydrophilic nature of their cellulose fibers. They can have poor resistance to water and oil, high permeability to gases, and can be vulnerable to microbial attack. To combat these issues, paper and paperboard used in food packaging are extrusion coated with plastics or laminated with aluminum or plastic foils to produce several paper grades for food packaging. These materials and processes, however, have an adverse effect on the sustainability of packaging because they use non-renewable polymers produced from petroleum, which raises the product's ecological footprint, reduces the old package's ability to be recycled and biologically degraded, and increases costs due to rising petrochemical and disposal pricing.

Starch is a natural polymer that has many desirable properties, including biocompatibility, renewability, biological degradability, and availability. It is also easily thermoplasticized. Natural sources of starch are made up mostly of amylose and amylopectin. In essence, amylose is a straight chain with nearly all α-(1→4) linkages, whereas glucose residues in amylopectin are connected by α-(1→6) linkages. With a percentage of 70-85%, amylopectin is the primary constituent of starch and is a polymer with a molecular weight of 10⁷-10⁹ Daltons due to its extensively branched structure. This compares to the lower molecular weight of 10⁵-10⁶ Daltons for linear amylose.

Starch is a favorable natural polymer for the manufacturing of packaging material due to its renewability, availability, inexpensive cost, and biodegradability when used in its natural condition to create films with satisfactory tensile and gas barrier properties. In contrast to films made from synthetic polymers like polyethylene or polypropylene, non-plasticized starch films are brittle and suffer from low resistance to water and high sensitivity to wetness due to their hydrophilic nature. Therefore, plasticization and chemical modifications are needed to improve native starch's film production and material qualities.

A common strategy for enhancing starch's effectiveness in a variety of applications is crosslinking. Crosslinking has emerged as an effective method for enhancing the characteristics of starch films for packaging applications.

In recent years, there was a rapid proliferation of online shopping for delivery to homes and, as a result, there was an increase in the utilization of food packaging that was predominantly made of materials that are not biodegradable or renewable. Single-use paper plates and other paper products are becoming more popular day by day due to consumer demands for sustainability and changes in government policies now include bans on single-use plastic items. Even while the usage of paper plates and other food service products has drawn more attention owing to their environmental impact, they are not fully biodegradable due to the use of plastic coating materials.

The present disclosure provides a biodegradable coating that can be applied to food-service products to achieve excellent barrier properties and high rigidity, and will provide an alternative to food-service products solely comprising a conventional plastic coating.

Certain embodiments of the present disclosure are directed to a biobased coating composition comprising at least one starch, at least one crosslinker, at least one plasticizer and at least one pH adjuster, wherein the at least one starch is a modified starch and the at least one crosslinker is a citric acid crosslinker present in an amount ranging from 1 to 10 percent by dry weight of the biobased coating.

A further embodiment of the present disclosure is directed to a paperboard product comprising a frontside biobased coating comprising at least one starch, at least one crosslinker, at least one plasticizer and at least one pH adjuster, wherein the starch is a modified starch and the crosslinker is a citric acid crosslinker present in an amount ranging from 1 to 10 percent by dry weight of the frontside biobased coating. A further embodiment is directed to a paper plate comprising this frontside biobased coating.

Another embodiment of the present disclosure is directed to paperboard product comprising a coatings package comprising a backside additive and a frontside biobased coating comprising at least one starch, at least one crosslinker, at least one plasticizer and at least one pH adjuster, wherein the at least one starch is a modified starch and the at least one crosslinker is a citric acid crosslinker present in an amount ranging from 1 to 10 percent by dry weight of the frontside biobased coating.

In some of these embodiments, the amount of starch ranges from 76.92% to 94.34% by dry weight of biobased coating composition. In some embodiments, the amount of citric acid ranges from 0.94% to 7.69% by dry weight of biobased coating composition. In some embodiments, the amount of glycerol ranges from 4.72% to 15.38% by dry weight of biobased coating composition.

Other embodiments of the present disclosure are directed to a biobased coating composition comprising at least one starch, at least one petroleum-based polymeric material, at least one crosslinker, at least one plasticizer and at least one pH adjuster, wherein the at least one starch is a modified starch and the at least one petroleum-based polymeric material is present in an amount ranging from 1% to 50% dry weight of the biobased coating.

In some embodiments, after the biobased coating composition is made, at least one petroleum-based polymeric material is added. In some of these embodiments, the biobased coating composition may comprise a ratio of starch to at least one petroleum-based polymeric material from 95:1 to 48:50. In some embodiments, the amount of at least one petroleum-based polymeric material is less than or equal to 50% of the amount of starch in the biobased coating composition.

Additional embodiments of the present disclosure is directed to a paperboard product comprising a frontside biobased coating comprising at least one starch, at least one petroleum-based polymeric material, at least one crosslinker, at least one plasticizer and at least one pH adjuster, wherein the starch is a modified starch and the at least one petroleum-based polymeric material is present in an amount ranging from 1 to 50 percent by dry weight of the frontside biobased coating.

Another embodiment of the present disclosure is directed to paperboard product comprising a coatings package comprising a backside additive and a frontside biobased coating comprising at least one starch, at least one petroleum-based polymeric material, at least one crosslinker, at least one plasticizer and at least one pH adjuster, wherein the at least one starch is a modified starch and the at least one petroleum-based polymeric material is present in an amount ranging from 1 to 50 percent by dry weight of the biobased coating.

In some of these embodiments comprising at least one petroleum-based polymeric material, the amount of starch ranges from 76.92% to 94.34% by dry weight of biobased coating composition. In some embodiments, the amount of citric acid ranges from 0.94% to 7.69% by dry weight of biobased coating composition. In some embodiments, the amount of glycerol ranges from 4.72% to 15.38% by dry weight of biobased coating composition.

### BRIEF DESCRIPTION OF THE DRAWINGS

FIG. 1 depicts SEM microphotographs of a citric acid-crosslinked starch coated paper in accordance with the present disclosure.

FIG. 2 depicts FTIR absorption spectra of starch and crosslinked starch with different level of citric acid in accordance with the present disclosure.

FIG. 3 depicts hot oil absorption of coated papers in accordance with the present disclosure.

FIG. 4 depicts the Bacon grease resistance of coated papers in accordance with the present disclosure.

FIG. 5 depicts water absorption of coated papers in accordance with the present disclosure.

FIG. 6 depicts hot water absorption of coated papers in accordance with the present disclosure.

FIG. 7 depicts water drop tests of biocoated paper plates in accordance with the present disclosure.

FIG. 8 depicts pilot-scale coating preparation and evaluation of paper plates in accordance with the present disclosure.

Certain embodiments of the present disclosure is directed to a biobased coating composition comprising at least one modified starch, at least one crosslinker, at least one plasticizer and at least one pH adjuster, wherein the at least one crosslinker is a citric acid crosslinker present in an amount ranging from 1 to 10 percent by dry weight of the biobased coating composition.

Non-limiting examples of suitable modified starches according to the present disclosure include cereal starches (e.g., corn, wheat, rice, barley, sorghum, millet, oat, rye), tuber starches (e.g., potato, sweet potato, cassava, arrowroot), ethylated starches, amylopectin starches, oxidized starches, acetylated starches, cationic starches, and combinations thereof. In certain embodiments of the present disclosure, the amylopectin starches are selected from highly branched amylopectins. Non-limiting examples of suitable modified starches include Ingredion™ PenCote™ L800, Ingredion™ PenCote™ L1000, Ingredion™ Redifilm™ 5400, Ingredion™ Redifilm™ 5800, Ingredion™ Redifilm™ 2030, and EcoSynthetix® EcoSphere® 2330.

The at least one modified starch can be present in an amount ranging from 70% to 95% dry weight of biobased coating composition, and non-limiting exemplary ranges include from 70% to 93% by dry weight, from 70% to 91% by dry weight, from 70% to 89% by dry weight, from 70% to 87% by dry weight, from 70% to 85% by dry weight, from 70% to 83% by dry weight, from 75% to 95% by dry weight, from 75% to 93% by dry weight, from 75% to 91% by dry weight, from 75% to 89% by dry weight, from 75% to 87% by dry weight, from 75% to 85% by dry weight, from 75% to 83% by dry weight, from 80% to 95%, from 80% to 93% by dry weight, from 80% to 91% by dry weight, from 80% to 89% by dry weight, from 80% to 87% by dry weight, from 80% to 85% by weight, from 85% to 95%, from 85% to 93% by dry weight, from 85% to 91% by dry weight, from 85% to 89% by dry weight, and from 85% to 87% by dry weight.

In some embodiments, the amount of starch ranges from 76.92% to 94.34% by dry weight of biobased coating composition. In some embodiments, the amount of citric acid is from 0.94% to 7.69% by dry weight of biobased coating composition. In some embodiments, the amount of glycerol is from 4.72% to 15.38% by dry weight of biobased coating composition.

In some embodiments, after the biobased coating composition is made, at least one petroleum-based polymeric material is added. In some embodiments, the biobased coating composition may comprise a ratio of starch to at least one petroleum-based polymeric material ranging from 93.4:1 to 47.17:50 and from 76.15:1 to 38.46:50. In some embodiments, the biobased coating composition comprises an amount of at least one petroleum-based polymeric material that is less than or equal to 50% of the amount of starch in the biobased coating composition.

Non-limiting examples of suitable crosslinkers include organic acids (e.g., citric acid, tartaric acid, succinic acid), glyoxylic acid, glyoxal, potassium zirconium crosslinkers, ammonia zirconium crosslinkers, and sodium trimetaphosphate crosslinkers, present in an amount of 1 to 10 parts, based on 100 parts dry weight of the starch in the biobased formulation. Non-limiting, exemplary ranges of the amount of citric acid crosslinker include from 1 to 8 parts, from 1 to 6 parts, from 1 to 4 parts, from 1 to 3 parts, from 2 to 10 parts, from 2 to 8 parts, from 2 to 6 parts, from 2 to 4 parts, from 2 to 3 parts, from 3 to 10 parts, from 3 to 8 parts, from 3 to 6 parts, from 4 to 10 parts, from 4 to 8 parts, and from 4 to 6 parts. In certain embodiments, the crosslinker is present in an amount of from 2 to 3 parts by weight based on 100 parts dry weight of the starch in the biobased formulation, such as 2.5 parts by weight.

Certain embodiments of the present disclosure comprise citric acid as the crosslinker. Citric acid is an excellent candidate for use as a crosslinker for starch. It has three carboxylic groups, often referred to as a tricarboxylic acid, occurs naturally, and is considered a benign food ingredient (USFDA-approved). Citric acid can react with the hydroxyl moieties at the reducing part of the anhydroglucose chain and the other two reactive hydroxyl groups in the monomer.

To enhance the chemical, mechanical, and/or barrier properties (hot oil) of a coated material in these embodiments, starch can be crosslinked with FDA-approved citric acid, and the citric acid is present in an amount of 1 to 10 parts, based on 100 parts dry weight of the starch in the biobased formulation. Non-limiting, exemplary ranges of the amount of citric acid crosslinker include from 1 to 8 parts, from 1 to 6 parts, from 1 to 4 parts, from 1 to 3 parts, from 2 to 10 parts, from 2 to 8 parts, from 2 to 6 parts, from 2 to 4 parts, from 2 to 3 parts, from 3 to 10 parts, from 3 to 8 parts, from 3 to 6 parts, from 4 to 10 parts, from 4 to 8 parts, and from 4 to 6 parts. In certain embodiments, the citric acid crosslinker is present in an amount of from 2 to 3 parts by weight based on 100 parts dry weight of the starch in the biobased formulation, such as 2.5 parts by weight.

The at least one plasticizer can be selected from polyols (e.g., glycerol, sorbitol, mannitol, xylitol, propylene glycol, polyethylene glycol, etc.), or organic acid esters (e.g., triethyl citrate, tributyl citrate, acetyl tributyl citrate, acetyl triethyl citrate, etc.) and the plasticizer is present in an amount of from 5 to 20 parts, based on 100 parts dry weight of the starch in the biobased formulation. Non-limiting, exemplary ranges of the amount of the plasticizer include from 5 to 15 parts, from 5 to 13 parts, from 5 to 11 parts, from 7 to 15 parts, from 7 to 13 parts, from 7 to 11 parts, from 9 to 15 parts, from 9 to 13 parts, and from 9 to 11 parts. In certain embodiments, the plasticizer is present in an amount of from 9 to 11 parts by weight based on 100 parts dry weight of the starch in the biobased formulation, such as 10 parts by weight.

In some particular embodiments, the at least one plasticizer is selected from polyol plasticizers present in an amount of from 5 to 20 parts, based on 100 parts dry weight of the starch in the biobased formulation. Non-limiting, exemplary ranges of the amount of the plasticizer include from 5 to 15 parts, from 5 to 13 parts, from 5 to 11 parts, from 7 to 15 parts, from 7 to 13 parts, from 7 to 11 parts, from 9 to 15 parts, from 9 to 13 parts, and from 9 to 11 parts. In certain embodiments, the polyol plasticizer is a glycerol plasticizer present in an amount of from 9 to 11 parts by weight based on 100 parts dry weight of the starch in the biobased formulation, such as 10 parts by weight.

In a particular embodiment of the present disclosure, the coating system is comprised of eco-friendly materials selected from paper, starch, citric acid, and glycerol.

The at least one pH adjuster or neutralizing agent can be selected from sodium hydroxide, potassium hydroxide, ammonia, or liquid amines such as triethanol amine or ethylene diamine. In certain embodiments, the pH adjuster is sodium hydroxide. The pH adjuster is present amount in an amount sufficient to adjust the pH of the modified starch to at least 10 prior to the addition of the citric acid crosslinker. In certain embodiments, the pH adjuster is added to adjust the pH of the modified starch to at least 10.5 prior to the addition of the citric acid crosslinker. In further embodiments, the pH adjuster is added to adjust the pH of the modified starch to at least 11 prior to the addition of the citric acid crosslinker.

Other embodiments of the present disclosure are directed to paper food service product comprising a frontside biobased coating composition comprising at least one starch, at least one crosslinker, at least one plasticizer and at least one pH adjuster, wherein the at least one starch is a modified starch selected from amylopectin starches and the crosslinker is a citric acid crosslinker present in an amount ranging from 1 to 10 percent by dry weight of the frontside biobased coating composition. In certain embodiments of the present disclosure, the paperboard product comprises at least one amylopectin starch and at least one citric acid crosslinker, wherein the at least one amylopectin starch is present in an amount ranging from 0.2% to 20% by dry weight of the food service product, and the at least one crosslinker is present in an amount ranging from 1 to 10% by weight based on the dry weight of the starch content in the food service product.

Non-limiting examples of suitable amylopectins include PenCote™ L800, Redifilm™ 5800 and EcoSphere® 2330. Non-limiting, exemplary ranges of the amount of at least one amylopectin include from 0.2% to 18% by weight, from 0.2% to 15% by weight, from 0.2% to 12% by weight, from 0.2% to 10% by weight, from 0.2% to 8% by weight, from 0.2% to 6% by weight, from 0.2% to 4% by weight, from 0.2% to 2% by weight, from 0.2% to 1% by weight, from 0.2% to 0.5% by weight, from 0.5% to 20% by weight, from 0.5% to 18% by weight, from 0.5% to 15% by weight, from 0.5% to 12% by weight, from 0.5% to 10% by weight, from 0.5% to 8% by weight, from 0.5% to 6% by weight, from 0.5% to 4% by weight, from 0.5% to 2% by weight, from 0.5% to 1% by weight, from 1% to 20% by weight, from 1% to 18% by weight, from 1% to 15% by weight, from 1% to 12% by weight, from 1% to 10% by weight, from 1% to 8% by weight, from 1% to 6% by weight, from 1% to 4% by weight, from 1% to 2% by weight, from 2% to 20% by weight, from 2% to 18% by weight, from 2% to 15% by weight, from 2% to 12% by weight, from 2% to 10% by weight, from 2% to 8% by weight, from 2% to 6% by weight, from 2% to 4% by weight, from 3% to 20% by weight, from 3% to 18% by weight, from 3% to 15% by weight, from 3% to 12% by weight, from 3% to 10% by weight, from 3% to 8% by weight, from 3% to 6% by weight, from 5% to 20% by weight, from 5% to 18% by weight, from 5% to 15% by weight, 5% to 12% by weight, from 5% to 10% by weight, from 5% to 8% by weight, from 7% to 20% by weight, from 7% to 18% by weight, from 7% to 15% by weight, from 7% to 12% by weight, from 7% to 10% by weight, from 10% to 20% by weight, and from 10% to 18% by weight, and from 10% to 15% by weight.

In certain embodiments, the at least one amylopectin is present in an amount ranging from 10 to 20% based on the weight of the paper food service product. In other embodiments, the at least one amylopectin is present in an amount ranging from 0.2% to 5% based on the weight of the paper food service product. In further embodiments, the at least one amylopectin is present in an amount ranging from 5% to 10% based on the weight of the paper food service product.

It is contemplated that the at least one amylopectin is combined with the at least one citric acid crosslinker, the at least one plasticizer and the at least one pH adjuster in any of the amounts disclosed above.

The food service products according to all aspects of the present disclosure can include, for example, paper-based plates, paper-based straws, paper-based cups and cup lids, paper-based wraps and baking sheets, paper-based storage containers (including paper-based clamshells, paper-based cartons and paper-based boxes), paper-based trays (including paper-based flat trays and paper-based boats), paper-based labels (including as pizza labels, paper-based table products (including place mats and table coverings), and paper-based flatware.

These paper-based products may be made using commercially available paper stock. Non-limiting examples include paper stock available from Graphic Packaging International (GPI), such as GPI 20-point Premium plate stock, which has a target basis weight of 221.5 pounds/3000 ft², GPI 24-point plate stock, which has a target basis weight of 257.0 pounds/3000 ft², and Everest 28-point folding carton board, which has a target basis weight of 303.0 pounds/3000 ft². Additional non-limiting, exemplary paper stock includes 18-point Clearwater paperboard blanks, 20-point WestRock paperboard blanks, 22-point WestRock paperboard blanks, and 24-point SAPPI paperboard blanks. In certain embodiments, the basis weight of the paper stock and paperboard blanks range from 120 pounds/3000 ft² to 320 pounds/3000 ft², such as from 160 pounds/3000 ft² to 310 pounds/3000 ft², from 180 pounds/3000 ft² to 310 pounds/3000 ft², from 200 pounds/3000 ft² to 310 pounds/3000 ft², from 220 pounds/3000 ft² to 310 pounds/3000 ft², and from 140 pounds/3000 ft² to 310 pounds/3000 ft².

In certain embodiments of the present disclosure, the paper stock comprises greater than 12 lbs/3000 sq ft of size press starch applied to both sides of the paper stock, such as, for example, greater than 14 lbs/3000 sq ft, greater than 16 lbs/3000 sq ft, greater than 20 lbs/3000 sq ft, and greater than 24 lbs/3000 sq ft. In certain embodiments, a depth of penetration into the paper stock is equal to approximately ⅓ of the total caliper of the sheet per side. The smoothness targets in the paper stock can be increased to a range of 140 to 250 Sheffield units and less fiber would be required to achieve the caliper targets, such as, for example, a reduction of 20 lb/rm. Extra size press weight can be accounted for by less fiber weight, while the extra size press application should not close off sheet porosity but instead can coat the individual fibers in a deeper penetration. This bulkier paper stock can allow more size press starch to be applied with a deeper penetration, and a more porous sheet surface can allow more moisture to be removed in a size press dryer section.

Non-limiting examples of suitable size press starches according to the present disclosure include the modified starches described above, such as ethylated starches, amylopectin starches, and combinations thereof. In certain embodiments of the present disclosure, the amylopectin starches are selected from highly branched amylopectins. Non-limiting examples of suitable modified starches include Ingredion™ PenCote™ L800, Ingredion™ PenCote™ L1000, Ingredion™ Redifilm™ 5400, Ingredion™ Redifilm™ 5800, Ingredion™ Redifilm™ 2030, and EcoSynthetix® EcoSphere® 2330. In certain embodiments, the use of these modified starches could result in less water drying compared to conventional starches because these modified starches have less viscosity and higher solids than conventional starches.

In a particular embodiment, Ingredion™ Redifilm™ 5800 and EcoSynthetix® EcoSphere® 2330 (both corn starch based) were processed in a cold extrusion process to remove the ˜50% by dry-weight fraction linear amylose that does not contribute to paper strength and acts as a nutrient for various biological strains in warm ˜110-120 deg F., paper machine water systems. The Amylose addition requires complex and costly biocide addition and management/process control schemes, extensive shutdown day caustic and acid boilouts. Human cleaning with washup hoses and cleaning tools/materials can also be required in tanks and equipment, exposing employees to various strains of biological buildup, hazardous OSHA regulated confined space entries, lockout-tagout, slips/falls/heat exposure/symptoms of sickening/lack of oxygen/hydrogen sulfide gas inhalation, etc. The wet-end cleaning, in part driven by conventional starch addition, can often become the critical path on paper machine shutdowns. The ˜50% by dry-weight fraction amylopectin is the highly branched crystalline portion of starch that acts to improve strength. Another benefit is that amylopectin does not act as a biological nutrient, thereby eliminating the need for biocide, boilouts and the extensive cleanups described earlier, and reducing the risk of odor complaints in the final paper product.

According to the present disclosure, the paper stock can be combined with a bleached chemi-thermomechanical pulp (BCTMP). BCTMP is a type of pulp produced through a combination of chemical and mechanical processes in which wood chips, such as hardwood and/or softwood, are subjected to both chemical and thermal treatments. The chemical treatment involves the use of sodium sulfite or sodium bisulfite to break down the lignin in the wood. The thermal treatment involves steaming the wood chips, to soften the wood chip and separate the wood fibers. The BCTMP can be added to a conventional paper stock pulp to form a homogeneous mixture, or the BCTMP can be added as a separate layer in combination with one or more layers of conventional paperstock. In some embodiments, the BCTMP layers is combined with a single layer of conventional paperstock and in other embodiments, the BCTMP layer is sandwiched between two layers of conventional paperstock.

In certain embodiments, the final paper blank or pulp comprises from 5 to 40% by weight BCTMP, such as, for example, from 5 to 35% by weight BCTMP, from 5 to 30% by weight BCTMP, from 5 to 35% by weight BCTMP, from 5 to 20% by weight BCTMP, from 5 to 15% by weight BCTMP, 5 to 10% by weight BCTMP, from 10 to 40% by weight BCTMP, from 10 to 35% by weight BCTMP, from 10 to 30% by weight BCTMP, from 10 to 25% by weight BCTMP, from 10 to 20% by weight BCTMP, from 15 to 40% by weight BCTMP, from 15 to 35% by weight BCTMP, from 15 to 30% by weight BCTMP, from 15 to 25% by weight BCTMP, from 20 to 40% by weight BCTMP, from 20 to 35% by weight BCTMP, from 20 to 30% by weight BCTMP, from 25 to 40% by weight BCTMP, from 25 to 35% by weight BCTMP, and from 30 to 40% by weight BCTMP.

Paper-based products according to the present disclosure can be press molded from a paper blank or pulp molded from a wet-processed pulp.

In certain embodiments, the present disclosure is directed to a paper plate comprising a frontside biobased coating composition comprising at least one starch, at least one crosslinker, at least one plasticizer and at least one pH adjuster, wherein the at least one starch is a modified starch selected from amylopectin starches and the crosslinker is a citric acid crosslinker present in an amount ranging from 1 to 10 percent by weight of the frontside biobased coating composition. It is contemplated that the at least one modified starch, the at least one citric acid crosslinker, the at least one plasticizer and the at least one pH adjuster can be combined in any of the amounts disclosed above.

Another embodiment of the present disclosure is directed to paperboard product comprising a coatings package comprising a backside additive and a frontside biobased coating composition comprising at least one starch, at least one crosslinker, at least one plasticizer and at least one pH adjuster, wherein the at least one starch is a modified starch and the at least one crosslinker is a citric acid crosslinker present in an amount ranging from 1 to 10 percent by dry weight of the frontside biobased coating composition, and wherein the paperboard product is a paper plate. It is contemplated that the components of the frontside biobased coating composition can be combined in any of the amounts disclosed above.

In these embodiments, the backside additive comprises at least one modified starch as disclosed above. Non-limiting, exemplary ranges of the amount of at least one modified starch in the backside additive include from 2 to 20% by weight, such as from 2% to 18% by weight, from 2% to 15% by weight, from 2% to 12% by weight, from 2% to 10% by weight, from 2% to 8% by weight, from 3% to 20% by weight, from 3% to 18% by weight, from 3% to 15% by weight, from 3% to 12% by weight, from 3% to 10% by weight, from 3% to 8% by weight, from 5% to 20% by weight, from 5% to 18% by weight, from 5% to 15% by weight, 5% to 12% by weight, from 5% to 10% by weight, from 5% to 8% by weight, from 7% to 20% by weight, from 7% to 18% by weight, from 7% to 15% by weight, from 7% to 12% by weight, from 7% to 10% by weight, from 10% to 20% by weight, and from 10% to 18% by weight, and from 10% to 15% by weight.

In these embodiments, the backside additive also comprises at least one crosslinker, and non-limiting examples of suitable crosslinkers include glyoxal crosslinkers, potassium zirconium crosslinkers, ammonia zirconium crosslinkers, citric acid crosslinkers, and combinations thereof. In embodiments wherein the backside additive comprises a citric acid and/or glyoxal crosslinker, non-limiting, exemplary ranges of the amount of the citric acid/glyoxal crosslinker include from 0.5 to 6% dry weight of the starch, such as 0.5% to 5.5% by weight, 0.5% to 5% by weight, 0.5% to 4.5% by weight, 0.5% to 4% by weight, 0.5% to 3.5% by weight, 0.5% to 3% by weight, 0.5% to 2.5% by weight, 0.5% to 2% by weight, 1% to 5.5% by weight, 1% to 5% by weight, 1% to 4.5% by weight, 1% to 4% by weight, 1% to 3.5% by weight, 1% to 3% by weight, 1% to 2.5% by weight, 1.5% to 5.5% by weight, 1.5% to 5% by weight, 1.5% to 4.5% by weight, 1.5% to 4% by weight, 1.5% to 3.5% by weight, and 1.5% to 3% by weight. In embodiments when the backside additive comprises at least one zirconium and ammonia crosslinker, non-limiting, exemplary ranges of the amount of zirconium and ammonia crosslinkers include 0.5% to 5% by weight, 0.5% to 4.5% by weight, 0.5% to 4% by weight, 0.5% to 3.5% by weight, 0.5% to 3% by weight, 0.5% to 2.5% by weight, 0.5% to 2% by weight, 0.5% to 1.5%, by weight, 1% to 4.5% by weight, 1% to 4% by weight, 1% to 3.5% by weight, 1% to 3% by weight, 1% to 2.5% by weight, 1% to 2% by weight, 1.5% to 4.5% by weight, 1.5% to 4% by weight, 1.5% to 3.5% by weight, 1.5% to 3% by weight, 1.5% to 2.5% by weight, 2% to 4.5% by weight, 2% to 4% by weight, 2% to 3.5% by weight, 2% to 3% by weight, and 2% to 2.5% by weight.

In further embodiments, the backside additive comprises one of the following combinations:
Ingredion™ PenCote™ L800 and a glyoxal crosslinker;
Ingredion™ Redifilm™ 5800 and a glyoxal crosslinker;
EcoSynthetix® EcoSphere® 2330 and a glyoxal crosslinker;
Ingredion™ PenCote™ L800 and a potassium zirconium crosslinker;
Ingredion™ Redifilm™ 5800 and a potassium zirconium crosslinker; and EcoSynthetix® EcoSphere® 2330 and a potassium zirconium crosslinker.
   It is contemplated that these combinations of modified starches and crosslinkers can be combined in any of the amounts disclosed above.

Additional embodiments of the present disclosure are directed to a biobased coating composition comprising at least one starch, at least one petroleum-based polymeric material, at least one crosslinker, at least one plasticizer and at least one pH adjuster, wherein the at least one starch is a modified starch and the at least one petroleum-based polymeric material is present in an amount ranging from 1% to 50% dry weight of the biobased coating composition. It is contemplated that the components of these biobased coating compositions can be combined in any of the amounts disclosed above.

In these embodiments, after the biobased coating is made, at least one petroleum-based polymeric material is added. In some of these embodiments, the biobased coating composition comprises a ratio of starch to at least one petroleum-based polymeric material ranging from 95:1 to 48:50. In certain embodiments, the biobased coating composition may comprise a ratio of starch to at least one petroleum-based polymeric material ranging from 90:1 to 46:50, such as from 85:1 to 44:50, from 82:1 to 42:50, or from 80:1 to 40:50. In a particular embodiment, the ratio may range from 93.4:1 to 47.17:50 or from 76.15:1 to 40:50. In some of these embodiments, the biobased coating composition comprises an amount of at least one petroleum-based polymeric material that is less than or equal to 50% of the amount of starch in the biobased coating composition.

In these embodiments, the at least one petroleum-based polymeric material can be selected from polyethylene terephthalate, polyolefins, including polyethylene and polypropylene, polyvinyl chloride, and polystyrene. In some embodiments, the at least one petroleum-based polymeric material can be selected from Polyethylene (PE), LDPE (Low-Density Polyethylene), LLDPE (Linear Low-Density Polyethylene, HDPE (High-Density Polyethylene, Polypropylene (PP), Polyvinyl Chloride (PVC), Polystyrene (PS), Polyethylene Terephthalate (PET/PETE), Polyamide (Nylon, PA), Ethylene Vinyl Alcohol (EVOH), Ethylene-Vinyl Acetate (EVA), Acrylonitrile-Butadiene-Styrene (ABS), Acrylic polymers (methyl acrylate, ethyl acrylate, acrylic acid, butyl acrylate), Styrene-Butadiene & Acrylic Latex (SBR), Polyvinyl Alcohol (PVOH), Ethylene-Acrylic Acid (EAA), Ethylene-Methacrylic Acid (EMAA), Polyethylene Glycol (PEG), Polyethylene Dispersions (aqueous PE), phenolic resins, and polyurethane (PU).

Additional embodiments of the present disclosure is directed to a paperboard product comprising a frontside biobased coating comprising at least one starch, at least one petroleum-based polymeric material, at least one crosslinker, at least one plasticizer and at least one pH adjuster, wherein the starch is a modified starch and the at least one petroleum-based polymeric material is present in an amount ranging from 1 to 50 percent by dry weight of the frontside biobased coating composition.

Another embodiment of the present disclosure is directed to paperboard product comprising a coatings package comprising a backside additive and a frontside biobased coating composition comprising at least one starch, at least one petroleum-based polymeric material, at least one crosslinker, at least one plasticizer and at least one pH adjuster, wherein the at least one starch is a modified starch and the at least one petroleum-based polymeric material is present in an amount ranging from 1 to 50 percent by dry weight of the biobased coating composition.

In some of these embodiments comprising at least one petroleum-based polymeric material, the amount of starch is from 76.92% to 94.34% by dry weight of biobased coating composition. In some embodiments, the amount of citric acid is from 0.94% to 7.69% by dry weight of biobased coating composition. In some embodiments, the amount of glycerol is from 4.72% to 15.38% by dry weight of biobased coating composition.

In further embodiments, an exemplary process to produce the paper stock of the present disclosure employs a paper machine size press, which applies a solution of the modified starches and other materials to the surface of the paper.

This application can increase the stiffness, surface strength and/or the printing quality of the paper product.
Exemplary paper machine size presses include a hydraulic flooded nip size press, a metered blade size press, and a metered rod size press. The hydraulic flooded nip size press, also known as a “pond” type size press, operates by exposing a paper web to a pool of aqueous starch solution before it enters the nip between two press rolls. Features of the hydraulic flooded nip size press can include: at least one roll (e.g., a soft roll) covered with rubber or polyurethane; the paper web passing through a pool of starch solution; the press nip itself contributing to metering the applied amount; and horizontal, vertical, and inclined configurations. The hydraulic flooded nip size press is effective for applying the modified starch at lower machine speeds.

The metered blade size press, also known as a film press, uses a precision blade to control the amount of starch applied to the paper surface. Features of the metered blade size press include: a metering blade to control coating thickness; the elimination of the need for a starch pool, and the ability to operate a higher speeds compared to a flooded nip size press. The metered blade size press can provide better control over coating thickness and has the ability to use higher solids content in the starch solution.

The metered rod size press, also called a rod metering size press (RMSP), uses a precision metering rod to apply and control the volume of starch on the paper surface. Features of the metered blade size press include: precision metering to control coating application; a rod secured within a rod holder/rod bed; and a coating flows from a coating chamber to the rod. The metered rod size press can provide precise control over coating thickness, uniform application of the modified starch, and the ability to adjust coating thickness by changing rod thread size

Certain embodiments also contemplate the use of a size press into an off-machine coater, which could provide greater flexibility in paper production and coating processes. These embodiments allow the sizing process to be separated from the main paper machine; allow for the application of specialized coating applications; and provide a potential for higher coating speeds and more complex formulations. In these embodiments, the size press unit would be installed in a separate coating line; unwinding and rewinding stations for paper rolls would be incorporated; drying capacity to ensure proper starch setting would be added, and quality control measures for consistent coating application would be implemented. Benefits of this process could include increased production flexibility, an ability to apply specialized coatings without affecting main paper machine operations, and/or the potential for higher coating speeds and more complex formulations

The choice of size press technology depends on a variety of factors including paper grade, machine speed, and desired surface properties. The size presses can incorporate synthetic polymers, mineral particles, and even nanocellulose in combination with the starch. The development of size press technology can significantly improved size press efficiency and reduced web break frequency. By considering these various embodiments and technologies, paper manufacturers can select and implement the most appropriate size press configuration for their specific production needs and quality requirements.

### EXAMPLES

Exemplary Coating Formulation 1 (Ing-CA-2.5-Gly-10) is shown in Table 1:

TABLE 1
Formulation of the coating solution.

| | Solids | Parts by | Percentage |
|---|---|---|---|
| Component | Content | weight | of Coating |
| Starch - Ingredion ™ Redifilm ™ 5800 | 35% | 100 | 88.89% |
| Crosslinker - Citric acid monohydrate | 100% | 2.5 | 2.22% |
| (Fisher Chemical) | | | |
| Plasticizer - Glycerol (Sigma-Aldrich) | 99.5% | 10 | 8.89% |
| Total | | 112.5 | 100% |

A coating solution was prepared by using the formulation on dry part basis which is presented in the table above. Ingredion™ Redifilm™ 5800 starch was mixed with the required amount of deionized water and glycerol. Then the mixture was heated to 90° C. for 10 minutes and cooled to room temperature. Before adding citric acid, NaOH was added to adjust the at pH 11. This step serves to prevent the hydrolysis reaction of starch. The citric acid was then added to the mixture and heated to 90° C. for 20 minutes.

The wet coating properties (viscosity, solid content, and pH) of the crosslinked starch coating solutions were measured and summarized in Table 2. The viscosity of the coating solution was measured using Brookfield viscometer with spindle number 1 at 25° C. The solid content and the pH of the coating solution were measured using an infrared analyzer and pH meter, respectively.

TABLE 2
Wet coating properties of coating solutions.

| | Viscosity (cP) | | |
|---|---|---|---|
| | at 100 RPM with | Solid | |
| Sample ID | Spindle 1 | content (%) | pH |
| Ing-CA-0-Gly-10 | 26.9 ± 0.4 | 11.7 ± 0.3 | 5.43 ± 0.03 |
| Ing-CA-2.5-Gly-10 | 29.3 ± 0.3 | 12.6 ± 0.8 | 4.50 ± 0.03 |
| Ing-CA-5-Gly-10 | 26.3 ± 0.2 | 12.0 ± 0.8 | 4.49 ± 0.03 |
| Ing-CA-10-Gly-10 | 28.2 ± 0.4 | 11.9 ± 0.7 | 4.48 ± 0.02 |

The bench-top Mayer rod coating method was used in this study. Both single-layer and double-layer coatings were made by using the Mayer rod number 4. At first, the WestRock 20-pt papers were cut into 21×29.7 cm² and kept for preconditioning in a controlled chamber (23° C.) and 50% relative humidity (RH) for 24 hours. Then a coating solution was prepared, and coatings were applied by Mayer rod no. 4. After coating, the coated papers were immediately dried using a hot air drier for 90 seconds and kept at the room temperature for 1 hour for air drying. For double-layer coated papers, the second layer of coating was applied after the complete drying of the first layer and then dried in a hot air oven for 90 seconds. Finally, the coated papers were cut into a hand sheet size (˜199 cm²) and pressed in a Carver press (Hydraulic Units Model-3912) at 400° F. and 1000 lb. pressure for 1 second, where the coated papers were placed in between two metal hand sheet size plates. In the Carver presser, the pressure was applied for 1 second but the whole procedure took 1 minute, which helped in better curing at high temperatures. The control papers were prepared by following the same procedures. Finally, all the control and coated paper were kept for conditioning at 23° C. and at 50% RH for 24 hours. For comparison purposes, a few cork-coated paper samples were also prepared.

The coat weight was measured by the wet coating method. First, a measured amount (gram) of coating solution was taken in a syringe. Afterward, the paper with a known area was taken, and a paper towel with known weight was placed under the paper. After the coating application, the unused coating solution was wiped using a paper towel. Immediately after the coating, the weight gain (gram) by the paper towel was measured, and the coating solution used on the paper was calculated (gram) by subtracting the paper towel weight gain from the initial measured amount. The final coat weight was determined by the following equation:

$$Coat weight ( g / {m}^{2} ) = ( coating solution used ( grams ) \times \% solid ) / area of paper specimen ( {m}^{2} )$$

A standard Tappi T411 protocol was used to measure the thickness of the paper samples using a digital micrometer (Lorentzen & Wettre Micrometer). The thickness of each paper sample was recorded at 10 different locations and the results were reported as an average of 10 measurements.

The surface morphology of coated samples was examined using a FEI Verios 460L field emission SEM at an accelerating voltage of 2 kv and 13 pA current. Prior to imaging, samples were sputter-coated with a thin layer of gold in a low vacuum of 90 mTorr of Ar gas pressure with an accelerating voltage of 600 V for 3 minutes at a coating rate of 7 nm/min.

The chemical characterization was performed using ATR-FTIR instrument (PerkinElmer FTIR spectrophotometer Frontier, universal attenuated total reflectance (ATR) Sampling Accessory)) within the range of 650 to 4000 cm⁻¹ wavenumber with 4 cm⁻¹ resolution.

The bending stiffness of papers were measured according to TAPPI T 489 om-15 using the TABER® V-5 Stiffness Tester—Model 150-B. For stiffer materials, range weights of 500, 1000, and 2000 can be applied to the bottom of the pendulum. In this experiment, 1000 weight was applied, and the samples were deflected 15° angle to the left and right. The average reading was multiplied by 10 (according to the set-up chart for the particular range). The product is the stiffness value of the material measured in Taber Stiffness units which is equivalent to a gram centimeter (g·cm).

To measure the hot oil resistance of the coated papers, corn oil (Mazola) was used and D53004 Chromatint® Red IK Liquid dye was used to color the corn oil. At first, the weight of the sample specimen was measured and then it was placed in a sample holder by using a metal clamp. A paper towel was placed under the paper samples to track the oil penetration. The corn oil was heated to about 65-68° C. Ten (10) ml of hot oil was poured into the sample and kept for 20 minutes. By the end of 20 minutes, the oil was removed, and the remaining oil was wiped with a paper towel. An immediate inspection was carried out on the back side of the specimen to check for any soak-through and stains on the paper towel. Staining on the bottom of the specimen, without stains on the paper towel, is not a failure. Additionally, the final weight was measured, and absorption(g/m²) was calculated.

To test the absorption of grease on paper plates, a standard procedure for bacon microwave test on paper plates was used. For this test, Member Mark bacon strips and Super Premium paper towel were used, and the coated papers were cut into paper disc (hand sheet size). This test is somewhat similar to the “paper plate and towel method” of cooking bacon. The test procedure involves taking three pieces of Members Mark Super Premium paper towel, crumbling them into a ball, and placing the ball at the center of the paper sheet. Then three strips of bacon were directly placed on the paper towel ball. A paper towel was placed on top of the bacon, and the paper disc including the bacon was microwaved for three minutes. The bacon was removed with a tong and the tested plate was observed for grease penetration. The paper sheets were graded on a pass/fail criterion.

The water absorption test was performed following the modified T 441 om-09 method. From each test unit, specimens were cut to a size slightly greater than the outside dimensions of the ring of the apparatus, i.e., squares (2×2) in. The inside standard test area was 10 cm². The samples were cut to fit the shape of the test equipment, the initial weight was recorded, and 10 ml of water was poured in for one minute and 50 seconds. The water was poured out and remaining surface water was removed from the sample through blotting paper and a hand roller. The final weight of the samples was measured, and the absorption (g/m²) was calculated by subtracting the initial weight from final weight and dividing it by test area.

To measure the hot water resistance of the coated papers deionized water was used. At first, the weight of the sample specimen was measured and then it was placed in a sample holder by using a metal clamp. A paper towel was placed under the paper samples to monitor the water penetration. Water was heated to about

65-68° C. Ten (10) ml of hot water was poured into the sample and kept for 20 minutes. By the end of 20 minutes, the water was removed, and the remaining surface water was wiped from the sample with a paper towel. An immediate inspection was carried out on the back side of the specimen to check for any soak-through. Additionally, the final weight was measured, and absorption (g/m²) was calculated.

The physical properties of the papers (both control and coated papers) including coat weight, caliper, are shown in Table 3. It is understood that the coat weight gain is small in the case of single-layer and double-layer coating with crosslinked starch. The formation of a very thin layer of coating indicates the consumption of less coating materials in the process. On the other hand, when the coating was performed with only cork, a significantly higher coat weight gain was observed.

The physical properties of the coated papers are set forth in Table 3.

TABLE 3
Physical properties of coated papers.

| | Coat weight | Caliper |
|---|---|---|
| Sample ID | (g/m²) | (μm) |
| Uncoated (Control) | NA | 475.1 ± 2.0 |
| Cork-7965 | 6.9 ± 0.4 | 487.8 ± 8.8 |
| Ing-CA-0-Gly-10 | 1.9 ± 0.1 | 476.6 ± 9.5 |
| Ing-CA-2.5-Gly-10 | 2.1 ± 0.1 | 476.1 ± 10.7 |
| Ing-CA-5-Gly-10 | 2.0 ± 0.1 | 478.4 ± 5.4 |
| Ing-CA-10-Gly-10 | 1.9 ± 0.2 | 477.0 ± 4.2 |
| DL Ing-CA-2.5-Gly-10 | TL: 0.9 ± 0.1 | 478.4 ± 9.7 |
| | BL: 2.1 ± 0.1 | |

DL: Double layer,
TL: Top layer,
BL: Bottom layer

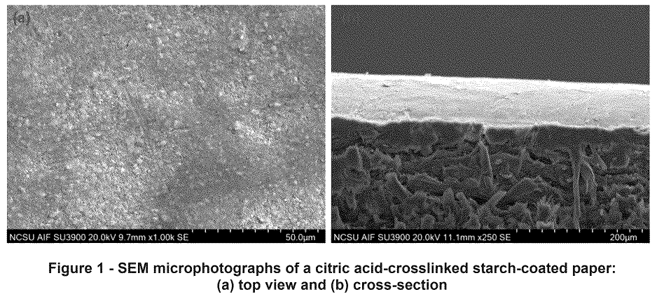

The morphological features of the coated papers were understood from the SEM images as shown in FIG. 1. To better understand the morphology, both the top and cross-section views of the coated papers were recorded during SEM imaging. In the top view (FIG. 1a), the surface appeared heterogeneous and rough with negligible presence of any tiny holes and cracks. The coated layer was clearly depicted in the cross-sectional view (FIG. 1b). The thickness of the coated layer seemed uniform. The fibrous structure of the paper was also visible in the cross-sectional view.

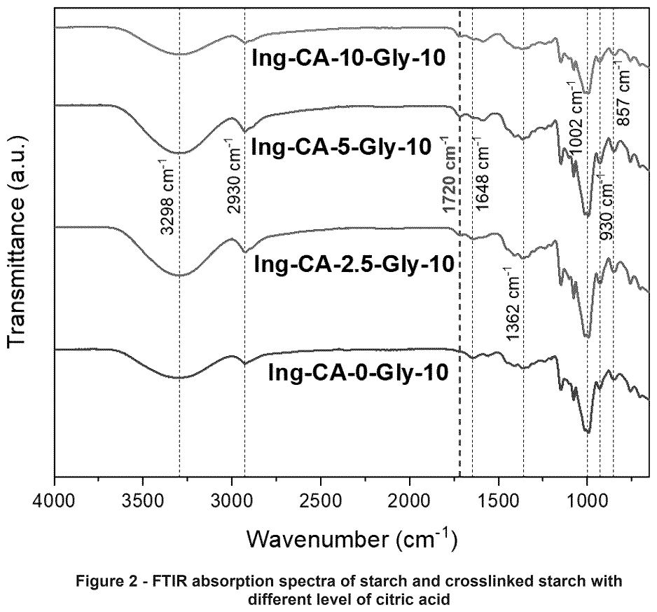

The FTIR spectra of Ingredion starch and cross-linked starches were recorded (FIG. 2) to study the chemical interaction between starch and citric acid. All starch films showed similar absorption bands except for an additional peak in the cross-linked starch film. The newly appeared peak at 1720 cm⁻(absent in Ingredion starch) is attributed to the C═O stretching vibration i.e., carbonyl group indicating the presence of ester bonds in the crosslinked starch films. This peak provides evidence for crosslinking reaction between the hydroxyl groups of starch with the carboxyl groups of citric acid. This crosslinking reaction helps form a coating with improved barrier and mechanical properties.

The bending stiffness of the samples was measured to study the improvement in mechanical properties and the results are depicted in Table 4 below.

TABLE 4
Bending stiffness of coated papers.

| Sample ID | Taber stiffness (g · cm) | % Increase |
|---|---|---|
| Uncoated (Control) | 297.5 ± 6.0 | NA |
| Cork-7965 | 326.6 ± 7.6 | NA |
| Ing-CA-0-Gly-10 | 305.0 ± 5.0 | 2.52 |
| Ing-CA-2.5-Gly-10 | 325.0 ± 5.0 | 9.24 |
| Ing-CA-5-Gly-10 | 314.2 ± 9.5 | 5.61 |
| Ing-CA-10-Gly-10 | 310.0 ± 13.2 | 4.20 |
| DL Ing-CA-2.5-Gly-10 | 345.0 ± 5.0 | 15.96 |

The crosslinked starch coated papers demonstrated 9.24 and 15.96% improvement in stiffness respectively for single-layer and double-layer coated paper compared to the uncoated control paper sample. This improvement shows that citric acid crosslinking of starch helps improve the mechanical strength of the coated papers which is highly desirable for food service items preparation.

The hot oil and water barrier properties of the coated papers were analyzed and summarized in Table 5. The control paper sample showed the highest absorption of hot oil. A single-layer coating with crosslinked starch dramatically reduced the hot oil absorption (˜14 times). This observation indicates that crosslinked starch coating is very effective in improving the hot oil barrier properties of paper. A double-layer coating with the same crosslinked starch solution further reduced the hot oil absorption (almost to zero) thus enhancing the barrier properties. Further, an immediate visual inspection showed no soak-through and/or stains on the towel paper placed underneath the coated papers. Cork coating is commonly used to develop barrier properties of papers industrially. Interestingly, cork-coated paper showed less hot oil barrier performance than the single or double-layer crosslinked starch-coated paper.

To demonstrate the barrier properties of the coated paper products, coated papers were subjected to bacon grease resistance tests and the results are shown in FIG. 4. Papers coated with both single-layer and double-layer crosslinked starch coating passed the bacon test as understood from the no penetration of bacon grease/oil through the sample as well as no spot on the back/opposite side of the coated papers. The results support that the crosslinked starch coating could be a promising approach to serving high-fat food items with paper plates.

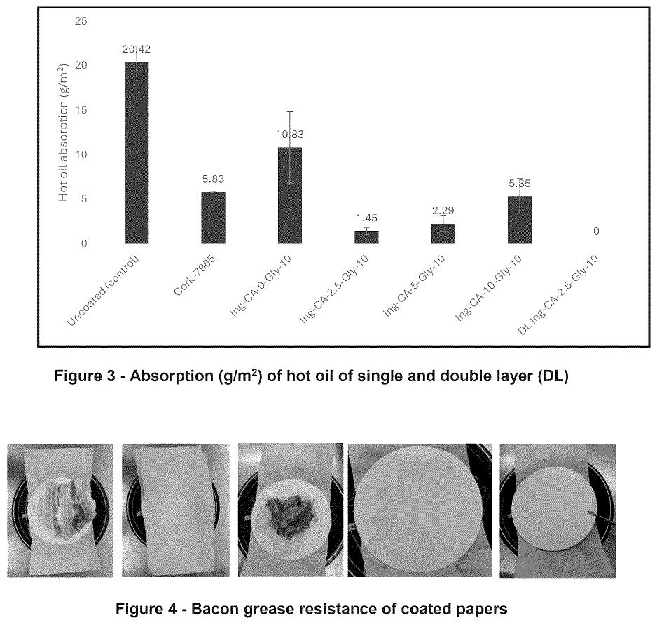

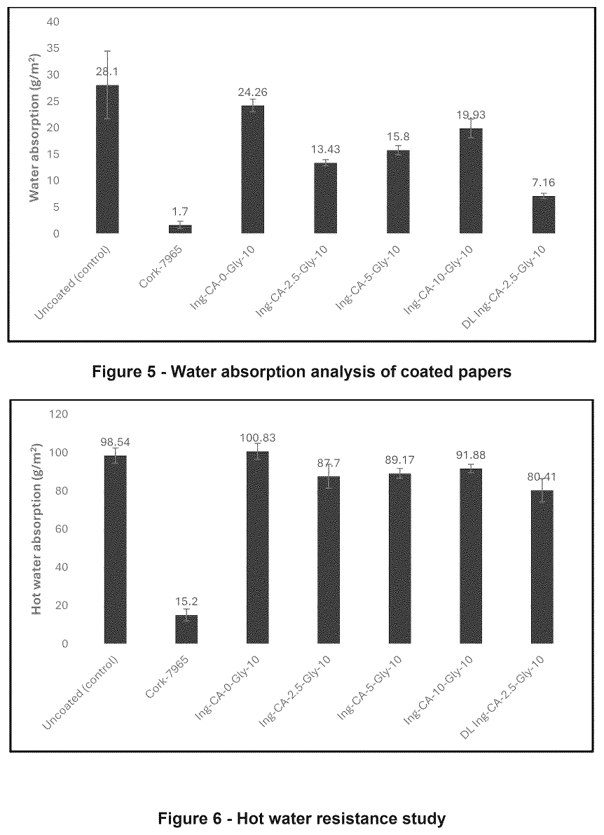

The results of the hot oil absorption experiments for single and double layered (DL) samples of Table 5 are illustrated in FIG. 3. The modified Cobb test was performed to study the water (room temperature) absorption properties of the samples and the results are shown in Table 5. The results of the water absorption and hot water absorption experiments for single and double layered (DL) samples of Table 5 are illustrated in FIGS. 5-6.

TABLE 5
Barrier properties of the coated papers.

| | Hot oil | Water | Hot water |
|---|---|---|---|
| | absorption | absorption | absorption |
| Sample ID | (g/m²) | (g/m²) | (g/m²) |
| Uncoated (Control) | 20.42 ± 1.8 | 28.10 ± 6.4 | 98.54 ± 4.0 |
| Cork-7965 | 5.83 ± 1.0 | 1.70 ± 0.7 | 15.20 ± 3.1 |
| Ing-CA-0-Gly-10 | 10.83 ± 4.0 | 24.26 ± 1.2 | 100.83 ± 4.2 |
| Ing-CA-2.5-Gly-10 | 1.45 ± 0.4 | 13.43 ± 0.6 | 87.70 ± 6.3 |
| Ing-CA-5-Gly-10 | 2.29 ± 0.9 | 15.80 ± 0.9 | 89.17 ± 2.6 |
| Ing-CA-10-Gly-10 | 5.35 ± 2.0 | 19.93 ± 1.8 | 91.88 ± 2.2 |
| DL Ing-CA-2.5-Gly-10 | 0.0 | 7.16 ± 0.5 | 80.41 ± 6.1 |

The single-layer coating improved water barrier performance which was further improved when a double-layer crosslinked starch coating was applied. The crosslinking helped reduce the hydrophilicity of starch which resulted in reduced water absorption. An immediate visual inspection showed no soak-through on the towel paper placed underneath the coated papers, thus passing the water barrier performance for food service items. The cork/plastic coating demonstrated superior water barrier performance compared to both single-layer and double-layer crosslinked starch-coated papers due to the cork being a highly hydrophobic material but doesn't biodegrade in the environment.

To further show the barrier properties of the coated paper in accordance with the present disclosure, a hot water resistance study was performed, and the results are shown in Table 5. The control paper sample (without coating) showed the highest water absorption which was reduced when a single-layer crosslinked starch coating was applied. Similar to the modified Cobb test, the absorption was further reduced when a double layer coating was applied. The water absorption was minimal when only cork coating was applied. The highly hydrophobic nature and relatively higher coat weight gain for the cork coating could be a possible reason explaining the minimum hot water absorption property. Even though the hot water absorption is higher for the cross-linked coatings, but no soak-through on the towel paper placed underneath the coated papers was observed, thus passing the water barrier performance for food service items.

### Exemplary Coating Formulation 2

TABLE 6
Formulation of coating with OSA-modified starch.

| | Solids | Parts by | Percentage |
|---|---|---|---|
| Component | Content | weight | of Coating |
| Starch - Unmodified corn starch | 95% | 97.0 | 86.22% |
| OSA - 2-Octen-1-ylsuccinic anhydride, | 100% | 3.0 | 2.67% |
| (mixture of cis and trans from Sigma- | | | |
| Aldrich) | | | |
| Crosslinker - Citric acid monohydrate | 100% | 2.5 | 2.22% |
| (Fisher Chemical) | | | |
| Plasticizer - Glycerol (Sigma-Aldrich) | 99.5% | 10 | 8.89% |
| Total | | 112.5 | 100% |

### Exemplary Coating Formulation 3

In this example coating formulation 1 in different configurations with cork coating was applied on the GPI 20-point paper. Formulations preparation was followed using similar process as described in example 1.

Multilayer coating was performed using a 20-pt GPI papers where the bottom layer was applied by rod-coating method (rod #4) with crosslinked biobased coating (Ing-CA-2.5-Gly-10). A thin top layer of plastic coating (cork-7965) was applied by flexo-coating method. For better comparison, a single-layer coating of cork-7965 was applied by a flexo coater.

The Cork coating properties (viscosity, solid content, and pH) were measured and summarized in Table 7. The viscosity of the coating solution was measured using Brookfield rheometer with spindle number 3 at 25° C. The solid content and the pH of the coating solution were measured using infrared analyzer and pH meter respectively.

TABLE 7
Wet coating properties of plastic-based cork coating.

| | | | |
|---|---|---|---|
| | Brookfield Viscosity (cP) | Solid | |
| Sample ID | at 100 RPM, Spindle 3 | content (%) | pH |

| | | | | |
|---|---|---|---|---|
| Cork-7965 | 464 ± 2.0 | 3 | 57.9 ± 0.3 | 9.51 |

The coat weight was measured by the wet coating method as described in earlier section.

A standard TAPPI T411 (T 411 om-2) protocol was used to measure the thickness of the paper samples using a digital micrometer (Lorentzen & Wettre Micrometer). The thickness of each paper sample was recorded at 10 different locations and the results were reported as an average of 10 measurements.

As shown in Table 8, the coat weight gain for the cork was 4.67±0.9 g/m². On the other hand, for multilayer approach, the bottom layer (BL) achieved a coat weight gain of 2.1±0.4 g/m² and the top layer had a coat weight gain of 0.78±0.1 g/m².

TABLE 8
Table 8: Physical properties of coated paper.

| | | Coat weight | Caliper |
|---|---|---|---|
| Sample ID | Coating method | (g/m²) | (μ) |
| Uncoated (Control) | NA | NA | 488.8 ± 2.3 |
| SL Cork-7965 | Flexo coating | 4.67 ± 0.9 | 491.0 ± 3.7 |
| | Anilox # 5.8 | | |
| | BCM | | |
| BL: Ing-CA-2.5- | BL # 4 rod | 2.23 ± 0.5 | 490.0 ± 2.8 |
| Gly-10 | coating | | |
| TL: Cork-7965 | TL: Flexo | 0.78 ± 0.1 | |

The overall barrier performance (hot oil, water, and hot water) of the multilayer-coated paper was significantly better than the control paper or cork coating alone (Table 9). The combined multi-layer cross-linked starch in a bottom layer (BL) and cork coating in a top layer (TL) showed 95.8% and 57.8% reduction in hot oil absorption compared to control (uncoated) paper and single layer cork coating, respectively. The multi-layer coating also reduced the water (room temperature) and hot water absorption by 54.4% and 19.5% compared to control uncoated paper. It is noteworthy that the barrier performance of the multilayer-coated paper was significantly better against hot oil absorption while achieving similar water barrier performance as the single-layer cork-coated paper with a reduced amount of plastic (reduced cork coating from 4.67 g/m² in single layer to 0.78 g/m² in multilayer).

TABLE 9
Barrier properties of coated papers.

| | Hot oil | Water | Hot water |
|---|---|---|---|
| | absorption | absorption | absorption |
| Sample ID | (g/m²) | (g/m²) | (g/m²) |
| Uncoated (Control) | 19.79 ± 1.3 | 55.30 ± 1.0 | 120.41 ± 5.9 |
| SL Cork-7965 (flexo) | 8.33 ± 2.2 | 24.80 ± 1.3 | 110.83 ± 0.4 |
| BL: Ing-CA-2.5-Gly-10 | 0.83 ± 0.3 | 25.23 ± 1.2 | 96.87 ± 1.7 |
| TL: Cork-7965 | | | |
| Percent reduction by | 95.8% | 54.4% | 19.5% |
| multilayer coating | | | |
| (compared to control) | | | |

### Exemplary Coating Formulation 4

A composite coating comprising the crosslinked starch and the plastic (Cork) coating was prepared (Table 10). The physical (basis weight and thickness) and mechanical (tensile strength and bending stiffness) properties of the composite coated papers were studied compared to the control paper. The composite coated papers showed better barrier performance (hot oil, hot water, Cobb test) than the control papers.

The GPI 20-pt control paper was used for composite coating. Ingredion RediFILM™ 5800 starch was used to prepare the biobased coating with glycerol as the plasticizer and citric acid as the crosslinker. For composite coating, cork-7965 was mixed with crosslinked starch coating as 20 dry parts. The pH of the coating solution was adjusted using 0.1 N sodium hydroxide (NaOH) and 0.1 N hydrochloric acid (HCl).

The coating solution was prepared following the formulation on a dry part basis, as presented in Table 10. To achieve the desired coating solid content, deionized water (DI) was added to the starch sample. For example, to prepare a 500 mL coating solution having 10% solid, 382.97 mL DI water was added to 99.30 g starch and mixed with a glass rod at room temperature. A required quantity of glycerol (3.77 g) at 10 dry part basis was added to the starch solution and heated at 90±5° C. with overhead stirring at 500 rpm. The heating at the desired temperature (90±5° C.) was continued for 10 minutes. Afterward, the pH of the solution was adjusted to 11±0.5 with 0.1 N sodium hydroxide (NaOH) solution to prevent the hydrolysis of starch in the next step (crosslinking). For a 2.5 dry-part basis, 0.94 g of citric acid (crosslinker) was added to the starch solution and dissolved using a glass rod. After citric acid mixing, the pH of the solution was adjusted to 4.5±0.5. It is noteworthy that the addition of citric acid (2.5 dry part) lowered the pH of the solution to −4.0. After this pH adjustment, the solution was heated at 90±5° C. with overhead stirring at 500 rpm. The heating at the desired temperature (90±5° C.) continued for 20 minutes, and then the solution was cooled to room temperature. For composite coating preparation, 20 dry parts (13.01 wet g) of Cork 7965 was added and mixed thoroughly using an overhead stirrer operated at 500 rpm for 10 minutes.

TABLE 10
Formulation of biocoating and plastic composite coating

| | Solids | Parts by | Percentage |
|---|---|---|---|
| Component | Content | weight | of Coating |
| Starch - Ingredion ™ Redifilm ™ 5800 | 35% | 100 | 75.47% |
| Plasticizer - Glycerol (Sigma-Aldrich) | 99.5% | 10 | 7.55% |
| Crosslinker - Citric acid monohydrate | 100% | 2.5 | 1.89% |
| (Fisher Chemical) | | | |
| Cork-7965 | 58% | 20 | 15.09% |
| Total | | 132.5 | 100% |

The wet coating properties (viscosity, solid content, and pH) of the coating solution were measured. The viscosity of the coating solution was measured using a Brookfield rheometer with spindle #1 at 25° C. The solid content and the pH of the coating solution were measured using an infrared analyzer and pH meter, respectively. The wet coating properties of the coating solution are summarized in Table 11.

TABLE 11
Wet coating properties of starch-cork composite coating

| | Viscosity (cP) at | Solid | |
|---|---|---|---|
| | 25° C. at 100 | content | |
| Sample ID | RPM, Spindle 1 | (%) | pH |
| Ing-CA-2.5-Gly-10-Cork-20 | 28.5 ± 0.3 | 11.3 ± 0.6 | 7.3 |

For coating applications, first, the GPI 20-point control paper was cut into 21 cm width and 29.7 cm length and kept for preconditioning in a controlled room at 23° C. and 50% Relative humidity (RH) for 24 hours. The paper was taped to the plexiglass sheet, and a bead of wet coating was applied and metered off using a Mayer rod #4. After coating, the samples were immediately dried by using a hot air drier for 90 seconds and kept at the room temperature for 1 hour for air drying.

Second, the coated papers were cut into a hand sheet size (˜199 cm²) and pressed in a Carver press (Hydraulic Units Model-3912) at 400° F. and 1000 lb. pressure for 1 second by placing the coated papers in between two metal plates. In the carver press, the pressure was applied for 1 second, but the whole process including loading and unloading the press took ˜1 minute. The control papers without coating were also pressed following the above procedure. Finally, all the control and coated paper were kept for conditioning at 23° C. and at 50% RH for 24 hours before testing.

The coat weight was measured by the wet coating method described in the earlier section.

A standard TAPPI T411 protocol was used to measure the thickness of the paper samples using a digital micrometer (Lorentzen & Wettre Micrometer). The thickness of each paper sample was recorded at 10 different locations and the results were reported as an average of 10 measurements.

The physical properties of the coated papers are shown in Table 12.

TABLE 12
Physical properties of the starch-cork composite coated papers.

| | Basis weight | Coat weight | Caliper |
|---|---|---|---|
| Sample ID | (g/m²) | (g/m²) | (μm) |
| Uncoated (Control) | 391.76 ± 1.8 | NA | 494.75 ± 2.7 |
| Ing-CA-2.5-Gly-10-Cork-20 | 393.86 ± 0.2 | 2.1 ± 0.1 | 495.5 ± 3.6 |

The tensile properties of papers were measured according to the TAPPI T 494 method using an Instron tensile tester. The bending stiffness of papers were measured according to the TAPPI T 489 om-15 using the TABER® V-5 Stiffness Tester—Model 150-B. For stiffer materials, range weights of 500, 1000, and 2000 can be applied to the bottom of the pendulum. In this experiment, 1000 weight was applied, and the samples were deflected 15° angle to the left and right. The average reading was multiplied by 10 (according to the set-up chart for the particular range). The product is the stiffness value of the material measured in Taber Stiffness units, which is equivalent to a gram centimeter (g·cm).

To evaluate the mechanical performance after coating, tensile strength, stretch and stiffness were measured, as shown in Table 13. The mechanical properties of the composite coated paper were better than the control paper.

TABLE 13
Mechanical properties of the starch-cork composite coated papers.

| | | Tensile | | Taber |
|---|---|---|---|---|
| | Force | index | Stretch | stiffness |
| Sample ID | (N) | (Nm/g) | (%) | (g · cm) |
| Uncoated | 346.08 ± 8.7 | 59.22 ± 1.5 | 2.29 ± 0.2 | 330 ± 5.0 |
| (Control) | | | | |
| Ing-CA-2.5- | 367.23 ± 8.2 | 62.75 ± 1.4 | 2.48 ± 0.04 | 353.3 ± 2.9 |
| Gly-10- | | | | |
| Cork-20 | | | | |

To measure the hot oil resistance of the coated papers, Mazola corn oil with D53004 Chromatint® Red IK Liquid dye was used. First, the weight of the coated sample was measured and then placed in a sample holder using a metal clamp. A paper towel was placed under the paper samples to track the oil penetration. The corn oil was heated to about 65-68° C. Ten (10) ml of hot oil was poured onto the sample and kept for 20 minutes. By the end of 20 minutes, the oil was removed, and the remaining oil was gently wiped off with a paper towel. An immediate inspection was carried out on the back side of the specimen to check for any soak-through and stains. Staining on the bottom of the specimen, without penetration, is not a failure. Additionally, the final weight was measured, and absorption (g/m²) was calculated.

Modified Cobb water test was performed following the T 441 om-09 method. From each test unit, specimens were cut to a size slightly greater than the outside dimensions of the ring of the apparatus, i.e., squares (2×2) in. The inside standard test area was 10 cm². The samples were cut to fit the shape of the test equipment, the initial weight was recorded, and 10 ml of water was poured in for one minute and 50 seconds. The water was poured out and any remaining surface water was removed from the sample by blotting paper with a hand roller. The final weight of the sample was measured, and the water absorption (g/m²) was calculated by subtracting the initial weight from final weight and dividing it by area.

To measure the hot water resistance of the coated papers, deionized water was used. At first, the weight of the sample specimen was measured, and then it was placed in a sample holder using a metal clamp. A paper towel was placed under the paper samples to monitor the water penetration. Water was heated to about 65-68° C. Ten (10) ml of hot water was poured into the sample and kept for 20 minutes. By the end of 20 minutes, the water was removed, and the remaining water was gently wiped off with a paper towel. An immediate inspection was carried out on the back side of the specimen to check for any soak-through. Additionally, the final weight was measured, and absorption(g/m²) was calculated. The oil-grease and water barrier properties of the coated papers were analyzed and summarized in Table 14. The composite-coated paper showed a 76.81% decrease in hot oil absorption compared to the control paper. The cross-linked coating with dense and compact coated layers helped improve the hot oil barrier performance. Further, the composite-coated paper showed reduction of in water (room temperature) absorption by 54.4% and hot water absorption by 14.48% compared to control paper.

TABLE 14
Barrier properties of the starch-cork composite coated papers.

| | Hot oil | Water | Hot water |
|---|---|---|---|
| | absorption | absorption | absorption |
| Sample ID | (g/m²) | (g/m²) | (g/m²) |
| Uncoated (Control) | 23.33 ± 5.9 | 51.36 ± 6.7 | 90.63 ± 3.3 |
| Ing-CA-2.5-Gly-10-Cork-20 | 5.41 ± 1.3 | 23.4 ± 0.9 | 77.5 ± 1.9 |
| % reduction by composite | 76.81 | 54.4 | 14.5 |
| coating when compared to | | | |
| control papers | | | |

### Exemplary Size Press Application

A metered blade size press is employed to produce a paper stock. Starch is added at 8% solids, or 92% water at 6-7 lbs/3000 ft², or 64 lbs/ton 20 pt. 50% Hard Yellow Pine, Hoffmaster-proprietary grade 1897 paper stock. Post Size-Press, the 92% water solution/portion that was added must be removed via steam heated dryer cans in the 3^{rd} dryer section (requiring energy and potentially slowing the machine speed).

TABLE 15
Trial data for adding Biocoating to Board

| | | CA2044, SBR-latex, or |
|---|---|---|
| | Biocoating | Rhobarr Additives |
| | (Dry parts) | (Dry parts) |
| Biocoating:C&A-2044DE | 70 | 30 |
| | 60 | 40 |
| | 50 | 50 |
| Biocoating:SBR-latex | 70 | 30 |
| | 60 | 40 |
| | 50 | 50 |
| Biocoating:Rhobarr-135 | 50 | 50 |
| Biocoating:Rhobarr-214 | 50 | 50 |
| Biocoating:Rhobar-320 | 50 | 50 |

### Biocoating Trials

Exemplary biocoatings were tested for various characteristics and properties. In the first trial, a biocoating having about 36% solid content was coated at a rate of 800 feet per minute on a first roller. The coat weight on the first roller was approximately 1.65 lbs/3000 ft² to approximately 1.74 lbs/3000 ft². In the first trial, the biocoating having about 32% solid content was coated at a rate of 400 feet per minute on a second roller. The coat weight on the second roller was approximately 1.33 lbs/3000 ft². In certain embodiments, the first roller is a pink roller and the second roller is a black roller. In some embodiments, the biocoating applied to the second roller is a diluted coating of the biocoating applied to the first roller. Both the biocoating applied to the first roller and the second roller exhibited picking and blocking properties and therefore may not be stored long-term. Picking may refer to the biocoating sticking to the surface of the roller, rather than peeling off with the remainder of the biocoating. Blocking may refer to the adhesion of the biocoating to an adjacent layer of the biocoating, rather than peeling off in individual layers of the biocoating.

For the second trial, a biocoating having about 30% solids was applied to a roller. The resulting coat weight was approximately 1.28 lbs/3000 ft² to approximately 1.39 lbs/3000 ft². The biocoating was heated to 100° F. for a period of time to reduce viscosity and dry the sample. The biocoating had a uniform appearance and ran at 400 feet per minute on the roller without any picking observed. The biocoating also exhibited high gloss.

For the second trial, another biocoating having about 30% solids was applied to another roller. The resulting coat weight was approximately 1.43 lbs/3000 ft². The biocoating was heated to 109° F. for a period of time to reduce viscosity and dry the sample. The biocoating had a relatively uniform appearance and ran at 800 feet per minute. Some streaking was observed in this exemplary experiment. The biocoating also exhibited high gloss.

Relative to the first trial, the biocoatings of the second trial had a reduced pH to assist with drying and crosslinking for the biocoating. Additionally, the biocoatings of the second trial eliminated back side water and starch to assist with drying and reduce blocking.

### Water Drop Test

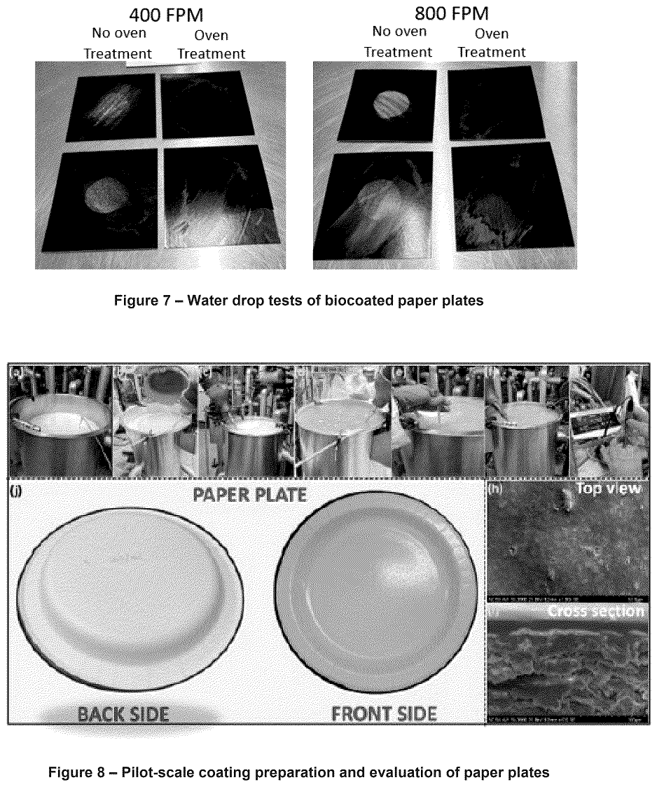

FIG. 7 displays the results of the biocoatings from the first and second trials, described above. Water was dropped onto the surface of each biocoating for 2 minutes and the water was subsequently wiped off. As can be seen in FIG. 7, the samples which were cured at 375° F. for 10 minutes exhibited very limited wiping of the ink. However, without curing the biocoating at 375° F. for 10 minutes results in ink wiping off when wiping off the water, with some moderate abrasion to the remaining biocoating.

In subsequent experiments, the curing of the biocoating samples were further improved by coating the biocoatings through a roll setting process. In addition, the curing of the biocoating samples were further improved by thermoforming the biocoatings.

### Plate Forming

The exemplary biocoatings were applied to form plates, using a plate forming die. The biocoating rolls formed did not exhibit blocking and were able to form plates. However, some of the biocoating formulation stuck to the plate forming die. The die sticking improved and/or decreased when the plate formulation temperature was reduced down to 300° F. Fingerprints, a tacky feel, and limited rigidity were observed in the formed plates.

Table 16 displays the results from the 400 and 800 feet per minute biocoated plate samples compared against a control plate sample. No sticking issues were observed when the coated papers were cured for 3 minutes at 400° F. In some embodiments, sticking was further reduced by curing the samples before forming them into plates. Additionally, in some embodiments, reducing the reel temperature improves the sticking properties of the formed biocoated plates.

TABLE 16
Physical Properties of Coated Papers using
biocoating from the second trial.

| | Basis weight | Coat weight | Caliper | Density |
|---|---|---|---|---|
| Sample ID | (g/m²) | (g/m²) | (μm) | (g/cm³) |
| Uncoated (control) | 358.78 ± 0.7 | NA | 469.57 ± 5.0 | 0.76 |
| 400 FPM | 366.60 ± 0.6 | 7.82 | 475.43 ± 1.7 | 0.77 |
| 800 FPM | 364.65 ± 0.5 | 5.87 | 473.33 ± 3.1 | 0.77 |

Table 17 displays the results for the water resistance properties of the sample biocoated plates compared against a control plate sample. The water absorption decreased significantly with the 400 and 800 feet per minute biocoated plate samples. Additionally, the water absorption decreased when curing for longer periods of time (i.e., from 1 minute at 400° F. to 3 minutes at 400° F.).

TABLE 17
Water Resistance Properties (Modified-Cobb Test)
using Biocoatings from the Second Trial.

| | Curing for 1 min at 400° F. | | Curing for 3 min at 400° F. | |
|---|---|---|---|---|
| | Absorption | % | Absorption | % |
| Sample ID | (g/m²) | Absorption | (g/m²) | Absorption |
| Uncoated | 56.50 ± 0.6 | 4.73 ± 0.04 | — | — |
| (control) | | | | |
| 400 FPM | 7.50 ± 0.4 | 0.63 ± 0.03 | 5.80 ± 1.1 | 0.33 ± 0.06 |
| 800 FPM | 4.45 ± 0.4 | 0.4 ± 0.03 | 2.70 ± 0.9 | 0.22 ± 0.08 |
| % Reduction | 86.7-92.1 | — | 89.7-95.2 | — |

Similarly, Table 18 displays the results for the hot oil resistance properties of the sample biocoated plates compared against a uncoated (control) plate sample. The hot oil absorption decreased significantly with 400 and 800 feet per minute biocoated plate samples.

TABLE 18
Hot oil Resistance Properties using
Biocoatings from the Second Trial

| | | | % Reduction in |
|---|---|---|---|
| | Absorption | | absorption |
| Sample ID | (g/m²) | % Absorption | (g/m² |
| Uncoated (control) | 33.75 ± 5.0 | 3.13 ± 0.12 | NA |
| 400 FPM | 0.90 ± 0.1 | 0.07 ± 0.009 | 97.3 |
| 800 FPM | 0.15 ± 0.04 | 0.01 ± 0.003 | 99.5 |

### Effect of Composite Coating on Barrier Properties

Several composite coatings comprising the biocoating (citric acid crosslinked starch Ing-CA-2.5-Gly-10) and C&A 2044DE, SBR-latex, and Rhobarr were prepared. The physical (coat weight and thickness) and barrier (hot oil absorption, water absorption) properties of the composite coated papers were tested for comparison against the control.

### Materials

The GPI 20 point paper was used. Ingredion RediFILM™ 5800 starch was used to prepare the biocoating with glycerol as the plasticizer and citric acid as the crosslinker. For composite coating, C&A 2044DE, SBR-latex, Rhobarr samples were mixed at different ratios with biocoating.

### Method of Composite Coating Preparation

The citric acid crosslinked starch coating Ing-CA-2.5-Gly-10 biocoating was prepared following the same formulation and procedure discussed in earlier section. The initial solid content of biocoating, C&A 2044DE, SBR-latex, Rhobarr samples were heated in an oven at 105° C. for 4 hours and measured. After that, several composite coatings were prepared using biocoating, C&A 2044DE, SBR-latex, Rhobarr in different ratio on dry percentage basis (Table 19). The mixture was stirred at 1200 rpm for 30 minutes at room temperature. The wet coating properties (solid content, and pH) of the coating solution were measured and presented in Table 20.

TABLE 19
Formulation of the composite coating solution.

| | | CA2044, SBR-latex, or |
|---|---|---|
| | Biocoating | Rhobarr Additives |
| | (Dry parts) | (Dry parts) |
| Biocoating:C&A-2044DE | 70 | 30 |
| | 60 | 40 |
| | 50 | 50 |
| Biocoating:SBR-latex | 70 | 30 |
| | 60 | 40 |
| | 50 | 50 |
| Biocoating:Rhobarr-135 | 50 | 50 |
| Biocoating:Rhobarr-214 | 50 | 50 |
| Biocoating:Rhobar-320 | 50 | 50 |

TABLE 20
Solid content and pH of composite coating solution.

| | Solid content | |
|---|---|---|
| Sample ID | (%) | pH |
| Biocoating | 24.19 | 4.50 |
| C&A-2044DE | 39.65 | 9.60 |
| SBR-latex | 49.68 | 6.27 |
| Rhobarr-135 | 44.34 | 7.48 |
| Rhobarr-214 | 43.36 | 7.12 |
| Rhobar-320 | 42.63 | 11.44 |
| Biocoating:C&A-2044DE-70:30 | 26.99 | 9.78 |
| Biocoating:C&A-2044DE-60:40 | 28.25 | 10.0 |
| Biocoating:C&A-2044DE-50:50 | 29.49 | 9.98 |
| Biocoating:SBR-latex -70:30 | 30.82 | 5.47 |
| Biocoating:SBR-latex -60:40 | 31.06 | 5.38 |
| Biocoating:SBR-latex -50:50 | 32.32 | 5.86 |
| Biocoating:Rhobarr 135-50:50 | 31.88 | 6.14 |
| Biocoating:Rhobarr 214-50:50 | 31.25 | 5.49 |
| Biocoating:Rhobarr 320-50:50 | 30.43 | 7.41 |

### Coating Method

Coatings were applied using an RK coater rod coating using rod number 2. First, the GPI 20-pt paper was preconditioned in a controlled chamber at 23 00 and 50% Relative humidity (RH) for 24 hours. The paper was placed on a flat surface on the RK coater and a bead of coating solution was applied and metered using rod no. 2 at 5 m/min speed. After coating, the coated papers were immediately dried by using a hot air drier for 90 seconds and kept at the normal room temperature for 1 hour for air drying. Finally, the coated papers were cut into a hand sheet size and pressed in a Carver presser (Hydraulic Units Model-3912) 400° F. at 1000 lb. pressure for 1 second, where the coated papers were placed in between two metal hand sheet size plates. In the carver presser, the pressure was applied for 1 second but the whole procedure took 1 minute which helped in better curing at high temperatures. The control papers were prepared by following the same procedures. Finally, all the control and coated paper were kept for conditioning at 23° C. and at 50% RH for 24 hours.

### Coat-Weight and Thickness of Coated Papers

First, a measured amount (gram) of coating solution was taken in a syringe. Afterward, an uncoated paper (base paper) was taken with a known area, and a paper towel was placed under the base paper. Before placing the paper towel under the base paper, its weight (gram) was measured. In this setup, the coating was performed by a rod coating method, and the unused coating solution was wiped using that paper towel. Immediately after the coating, the weight gain (gram) by the paper towel was measured, and the solution used in the coated paper was measured (gram). The final coat weight was measured by the following equations:

$$Solution used ( gram ) = measured amount ( gram ) of coating solution - the weight gain ( gram ) by the paper towel ( gram )$$

$$Coat weight = ( solution used ( gram ) \times \% solid ) / area of paper specimen ( {m}^{2} )$$

A standard TAPPI T411 (T 411 om-2) protocol was used to measure the thickness of the paper samples using a digital micrometer (Lorentzen & Wettre Micrometer). The thickness of each paper sample was recorded at different locations and the results were reported as an average of measurements.

### Barrier Property Analysis

### Hot Oil Test

To measure the hot oil resistance of the coated papers, corn oil (Mazola) was used and D53004 Chromatint® Red IK Liquid dye was used to color the corn oil. At first, the weight of the sample specimen was measured and then it was placed in a sample holder by using a metal clamp. A paper towel was placed under the paper samples to track the oil penetration. The corn oil was heated to about 65-68° C. Ten (10) ml of hot oil was poured into the sample and kept for 20 minutes. By the end of 20 minutes, the oil was removed, and the remaining oil was wiped with a paper towel. An immediate inspection was carried out on the back side of the specimen to check for any soak-through and stains. Staining on the bottom of the specimen, without penetration, is not a failure. Additionally, the final weight was measured, and absorption (g/m²) was calculated.

### Modified Cobb Test

This test was performed following the T 441 om-09 method. From each test unit, specimens were cut to a size slightly greater than the outside dimensions of the ring of the apparatus, i.e., squares (2×2) in. The inside standard test area was 10 cm². The samples were cut to fit the shape of the Cobb test equipment, the initial weight was recorded, and 10 ml of water was poured in for one minute and 50 seconds. The water was poured out and surplus water was removed from the sample through blotting paper and a hand roller. The weight of the samples was measured, and the absorption was calculated.

### Results and Discussions

### Coat Weight and Thickness of Coated Papers

The physical properties of the developed coated papers, including coat weight and thickness, are shown in Table 21.

TABLE 21
Physical properties of coated papers

| | Coat weight | Caliper |
|---|---|---|
| Sample ID | (g/m²) | (μm) |
| Uncoated (control) | NA | 480.2 ± 6.2 |
| Biocoating | 3.0 ± 0.1 | 485.3 ± 3.2 |
| C&A-2044DE | 5.7 ± 0.5 | 491.0 ± 3.2 |
| SBR-latex | 6.1 ± 0.4 | 488.3 ± 6.1 |
| Rhobarr-135 | 5.3 ± 0.5 | 487.33 ± 7.1 |
| Rhobarr-214 | 5.2 ± 0.3 | 484.11 ± 7.8 |
| Rhobar-320 | 5.5 ± 0.3 | 480.89 ± 6.6 |
| Biocoating:C&A-2044DE-70:30 | 3.2 ± 0.1 | 488.55 ± 2.8 |
| Biocoating:C&A-2044DE-60:40 | 3.2 ± 0.1 | 485.22 ± 7.3 |
| Biocoating:C&A-2044DE-50:50 | 3.3 ± 0.1 | 490.0 ± 6.7 |
| Biocoating:SBR-latex -70:30 | 3.3 ± 0.2 | 486.55 ± 6.2 |
| Biocoating:SBR-latex -60:40 | 3.4 ± 0.2 | 487.33 ± 7.0 |
| Biocoating:SBR-latex -50:50 | 3.5 ± 0.2 | 487.0 ± 3.5 |
| Biocoating:Rhobarr 135-50:50 | 4.6 ± 0.2 | 481.11 ± 3.1 |
| Biocoating:Rhobarr 214-50:50 | 4.5 ± 0.2 | 483.0 ± 7.3 |
| Biocoating:Rhobarr 320-50:50 | 4.4 ± 0.2 | 494.11 ± 9.2 |

### Barrier Property Analysis

The oil-grease and water barrier properties of the coated papers were analyzed and summarized in Table 22.

TABLE 22
Barrier properties of coated papers.

| | Hot oil absorption | Water absorption |
|---|---|---|
| Sample ID | (g/m²) | (g/m²) |
| Uncoated (control) | 36.33 ± 2.5 | 51.43 ± 3.2 |
| Biocoating | 0.0 | 16.33 ± 0.3 |
| C&A-2044DE | 0.0 | 0.76 ± 0.2 |
| SBR-latex | 0.0 | 18.06 ± 0.9 |
| Rhobarr-135 | 0.0 | 1.17 ± 0.2 |
| Rhobarr-214 | 0.0 | 1.57 ± 0.3 |
| Rhobar-320 | 0.88 ± 0.19 | 2.40 ± 0.3 |
| Biocoating:C&A-2044DE-70:30 | 0.43 ± 0.06 | 15.06 ± 0.4 |
| Biocoating:C&A-2044DE-60:40 | 0.56 ± 0.12 | 20.90 ± 0.8 |
| Biocoating:C&A-2044DE-50:50 | 0.60 ± 0.10 | 25.73 ± 1.1 |
| Biocoating:SBR-latex -70:30 | 0.0 | 27.63 ± 0.2 |
| Biocoating:SBR-latex -60:40 | 0.0 | 29.53 ± 0.5 |
| Biocoating:SBR-latex -50:50 | 0.0 | 31.20 ± 2.9 |
| Biocoating:Rhobarr 135-50:50 | 0.0 | 15.06 ± 0.4 |
| Biocoating:Rhobarr 214-50:50 | 0.0 | 20.9 ± 0.8 |
| Biocoating:Rhobarr 320-50:50 | 0.0 | 25.73 ± 1.1 |

### Hot Oil Barrier

The hot-oil barrier performance of the samples is summarized in Table 22. All coated papers exhibited excellent resistance, with negligible or no oil absorption observed.

### Water Barrier (Modified Cobb Test)

The water barrier properties of both the control and coated papers were evaluated using the modified Cobb test, and the results are presented in Table 22. For comparison, water absorption values for biocoating, C&A-2044DE, Rhobarr, and SBR-latex were also recorded. Both C&A-2044DE and Rhobarr exhibited excellent water resistance with only minor absorption. The biocoating reduced water uptake by 68.24% compared to the uncoated control. Although SBR-latex is generally recognized for its hydrophobicity, the SBR-latex-coated papers showed slightly higher absorption than the biocoating.

### Pilot-Scale Experiment

This study explored the preparation of food service plates through a pilot-scale experiment. The apparatus and procedures used to produce 20 gallons of coating solution are illustrated in FIG. 8. FIG. 8 displays a pilot scale production process and evaluation process of produced paper plates. FIG. 8 (a) illustrates an exemplary starch solution, FIG. 8 (b) illustrates a step of adding glycerol to the starch solution, FIG. 8 (c) illustrates a step of mixing the starch solution and added glycerol, FIG. 8 (d) illustrates a step of adding citric acid to the mixed starch and glycerol solution, FIGS. 8 (e)-(f) illustrate steps of heating the solution to 90° C. for 20 minutes, FIG. 8 (g) illustrates a step of determining the pH of the heated and mixed solution, FIG. 8 (h)-(i) illustrate scanning electron microscopy (SEM) images of the produced paper plate, and FIG. 8 (j) illustrates front and back sides of the produced paper plate.

The pilot trials were carried out under the optimal crosslinking condition identified in lab-scale experiments, namely 2.5 wt. % citric acid loading. To account for the faster drying rates in an industrial setting, the coating solution was formulated at a higher solid content (˜30%) compared to the lab-scale formulation (10%). Representative images of the coated paper plates are shown in FIG. 8h, highlighting the glossy appearance on the front surface. Examination of both sides confirmed that the plates exhibited the desired visual quality and structural integrity. Furthermore, the coated plate samples successfully withstood hot oil, water resistance, and cut resistance tests, demonstrating their potential for practical food service applications.

To further enhance the hydrophobicity of the coating, various crosslinkers, plasticizers, and additives can be employed, including citrate esters (e.g., acetyl ethyl citrate, acetyl tributyl citrate), fatty acid chlorides or anhydrides, and silane coupling agents.

### Gloss of Coated Paper

Gloss of coated papers was measured at a 60° geometry using a glossmeter in accordance with ASTM D523 method. Before measurement, samples were conditioned at 23±1° C. and 50±2% RH for 24 h, and the average of five readings was reported.

Paper gloss measures the degree of specular reflection of incident light, which indicates surface uniformity and smoothness. A glossmeter directs a light beam onto the paper at a specific angle and measures the intensity of the reflected light at the corresponding opposite angle. The greater the amount of specularly reflected light, the higher the gloss value, which is expressed in gloss units (GU). It is an important surface property of coated paper that measures the material's ability to reflect light, thereby influencing both its visual appearance and end-use performance. The gloss values of all coated paper are presented in Table 23. It is to be emphasized that the gloss of the biocoated paper improved significantly as compared to the uncoated and plastic-coated papers. Higher gloss values are typically associated with smoother, more uniform surfaces that enhance quality, color vibrancy, and aesthetic appeal.

TABLE 23
Gloss properties of coated paper

| Sample ID | Gloss (GU) |
|---|---|
| Biocoating | 57.8 ± 1.6 |
| C&A-2044DE | 35.2 ± 0.6 |
| SBR-latex | 49.1 ± 4.8 |
| Rhobarr-135 | 42.6 ± 2.0 |
| Biocoating:C&A-2044DE-70:30 | 10.5 ± 0.7 |
| Biocoating:C&A-2044DE-60:40 | 7.2 ± 1.0 |
| Biocoating:C&A-2044DE-50:50 | 5.4 ± 1.8 |
| Biocoating:SBR-latex -70:30 | 26.4 ± 3.1 |
| Biocoating:SBR-latex -60:40 | 56.2 ± 5.5 |
| Biocoating:SBR-latex -50:50 | 53.8 ± 3.4 |
| Biocoating:Rhobarr 135-50:50 | 41.4 ± 0.6 |
| Biocoating:Rhobarr 214-50:50 | 46.4 ± 2.3 |
| Biocoating:Rhobarr 320-50:50 | 10.3 ± 2.1 |

The surface gloss of the coated papers measured at a 60° angle varied markedly with formulation and fiber orientation (Table 23). The biocoating exhibited the highest specular reflection of light, with gloss values of 57.8±1.6 GU. Incorporation of plastics-based coatings into biocoating systems generally reduced gloss, and the effect was most pronounced in the biocoating/C&A-2044DE blends, where increasing the C&A ratio progressively lowered gloss. A similar trend was observed for biocoating/Rhobarr combination, although the magnitude of reduction was less. For the biocoating:SBR-latex series, the 70:30 blend displayed lower gloss (26.0±3.1 GU) than the 60:40 (56.2±5.5 GU) and 50:50 (53.8±3.4 GU) blends, possibly due to incompatibility at a lower proportion of latex, causing surface micro-roughness.

What is claimed is:

1. A biobased coating composition comprising at least one modified starch, at least one crosslinker, at least one plasticizer and at least one pH adjuster, wherein the at least one crosslinker is a citric acid crosslinker present in an amount ranging from 1 to 10 percent by dry weight of the biobased coating composition.

2. The biobased coating composition according to claim 1, wherein the at least one modified starch is an amylopectin.

3. The biobased coating composition according to claim 1, wherein the amylopectin is present in an amount ranging from 75% to 95% dry weight of biobased coating composition.

4. A paper plate comprising a biobased coating comprising at least one modified starch, at least one crosslinker, at least one plasticizer and at least one pH adjuster, wherein the at least one crosslinker is a citric acid crosslinker present in an amount ranging from 1 to 10 percent by dry weight of the biobased coating composition.

5. A paper plate according to claim 4, wherein the at least one modified starch is an amylopectin.

6. A paper plate according to claim 4, wherein the amylopectin is present in an amount ranging from 75% to 95% dry weight of biobased coating composition.

7. A biobased coating composition comprising at least one modified starch, at least one petroleum-based polymer, at least one crosslinker, at least one plasticizer and at least one pH adjuster, wherein the at least one petroleum-based polymer is present in an amount ranging from 1 to 50 percent by weight of the biobased coating composition.

8. The biobased coating composition according to claim 8, wherein the ratio of starch to plastic material ranges from 95:1 to 48:50.

9. The biobased coating composition according to claim 8, wherein the ratio of starch to plastic material ranges from 93.4:1 to 47.17:50.

10. The biobased coating composition according to claim 8, wherein the ratio of starch to plastic material ranges from 76.15:1 to 40:50.

11. The biobased coating composition according to claim 8, wherein the amount of at least one petroleum-based polymer is less than or equal to 50% of the amount of starch in the biobased coating composition.
